(19) United States
(12) Patent Application Publication
(10) Pub. No.: US 2004/0251757 A1
(43) Pub. Date: Dec. 16, 2004

(54) High efficiency torque converter

(76) Inventor: James M. Porter SR., Hudson, NH (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/864,164

(22) Filed: Jun. 9, 2004

Related U.S. Application Data
(60) Provisional application No. 60/477,185, filed on Jun. 10, 2003.

(51) Int. Cl. H02N 13/00; F16D 27/00

(52) U.S. Cl. 310/103; 464/29

(57) ABSTRACT

A torque converter includes a primary flywheel, a secondary flywheel, and a magnetic drive assembly magnetically and mechanically coupling the primary flywheel and the secondary flywheel. The magnetic drive assembly includes a fixed magnet and a rotatable magnet. The magnets are magnetically aligned and balanced through opposite magnetic poles. Rotation of the rotatable magnet creates a magnetic imbalance between the fixed magnet and the rotatable magnetic causing the secondary flywheel to be driven. The fixed magnet and the rotatable magnet can be Neodymium magnets.

### RELATED APPLICATION

This application claims the benefit of U.S. Provisional Application No. 60/477,185, filed Jun. 10, 2003, the entire teachings of which are incorporated herein by reference.

### BACKGROUND OF THE INVENTION

A flywheel energy storage system can be adapted to store rotational energy produced by rotating a flywheel disk at a high speed. The flywheel disk is typically rotated with an electric motor. The rotational energy to be stored can be made greater as the flywheel disk becomes heavier and is rotated at a higher speed.

A large-size and large-rated electric motor having a great magnitude of a driving torque is typically required to allow the flywheel disk having a heavy weight to rotate at a high speed from its stationary state within a short time. Large size electric motors are expensive and add to the total size of the system.

On the other hand, small sized electric motors tend to overload and burnout when an attempt is made to rotate a flywheel disk having a heavy weight at a high speed. Hence, the flywheel disk is required to be rotated gradually by a transmission mechanism which causes no or little overload to be imposed upon the electric motor. This system, however, requires a long time for rotating the flywheel disk at a high speed. Further, such a transmission mechanism produces energy such as heat, resulting in a loss of energy.

### SUMMARY OF THE INVENTION

There is a need to accelerate a flywheel disk from a starting position to a steady-state rpm while reducing power and the losses in the transmission mechanism.

There is provided a torque converter having a primary flywheel, a secondary flywheel, and a magnetic drive assembly magnetically and mechanically coupling the primary flywheel and the secondary flywheel. The magnetic drive assembly includes a fixed magnet and a rotatable magnet. The magnets are magnetically aligned and balanced through opposite magnetic poles. Rotation of the rotatable magnet creates a magnetic imbalance between the fixed magnet and the rotatable magnetic causing the secondary flywheel to be driven. The fixed magnet and the rotatable magnet can be Neodymium magnets.

The torque converter can also include a gap adjustor assembly, a pair of weighted flywheels, and a brake assembly. The gap adjustor assembly adjusts a gap between the fixed magnet and the rotatable magnet. The gap can be between 0.01 inch and 2 inches. One weighted flywheel can be coupled between the primary flywheel and the magnetic drive assembly and the other weighted flywheel can be coupled between the secondary flywheel and the magnetic drive assembly. The braking assembly can be coupled between the magnetic drive assembly and the secondary flywheel.

A mechanical input can be coupled to the primary flywheel. The mechanical input can be an electric motor, a waterwheel, a windmill, or a turbine. A mechanical output can be coupled to either the primary flywheel or the secondary flywheel, wherein power created from the mechanical output is routed to the mechanical input to provide a self-sustaining system.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1A is a side view of a high efficiency torque converter;

FIG. 1B is a perspective view of the high efficiency torque converter of FIG. 1A;

FIG. 2A is a top view of a primary drive assembly;

FIG. 2B is a side view of the primary drive assembly of FIG. 2A;

FIG. 2C is a bottom view of the primary drive assembly of FIG. 2A;

FIG. 2D is a perspective view of a rotor-stator pair of the primary drive assembly of FIG. 2A;

FIG. 2E is a detailed perspective view of the rotor-stator pair of FIG. 2D;

FIG. 3A is a top view of a flywheel assembly;

FIG. 3B is a side view of the flywheel assembly of FIG. 3A;

FIG. 3C is a bottom view of the flywheel assembly of FIG. 3A;

FIG. 4A is a top view of an optional weighted flywheel;

FIG. 4B is a side view of the optional weighted flywheel of FIG. 4A;

FIG. 4C is a bottom view of the optional weighted flywheel of FIG. 4A;

FIG. 5A is a top view of a brake/speed control assembly;

FIG. 5B is a side view of the brake/speed control assembly of FIG. 5A;

FIG. 5C is a bottom view of the brake/speed control assembly of FIG. 5A;

FIG. 6A is a perspective view on an electrical generation system using field pickup coils on the primary side of the torque converter of FIGS. 1A and 1B;

FIG. 6B is a cross-sectional view of an electrical generation system using field pickup coils on the secondary side of the torque converter of FIGS. 1A and 1B;

FIG. 6C is a perspective view on an electrical generation system using generators on the primary and secondary sides of the torque converter of FIGS. 1A and 1B;

FIG. 7 is a perspective view on a mechanical drive system using the torque converter of FIGS. 1A and 1B; and

FIG. 8 is a cross-sectional view of another embodiment of the torque converter of FIGS. 1A and 1B.

### DETAILED DESCRIPTION OF THE INVENTION

A description of preferred embodiments of the invention follows.

Generally, a high efficiency torque converter is a co-generation system which draws energy from two distinct sources; a mechanical or electromechanical source and a magnetic energy source. The mechanical or electromechanical source can be a conventional electric motor, turbine, waterwheel, windmill, or like source. The magnetic energy source can be produced from permanent magnets. The permanent magnets can be Neodymium Magnets (Nd—Fe—B) or any other good quality magnets.

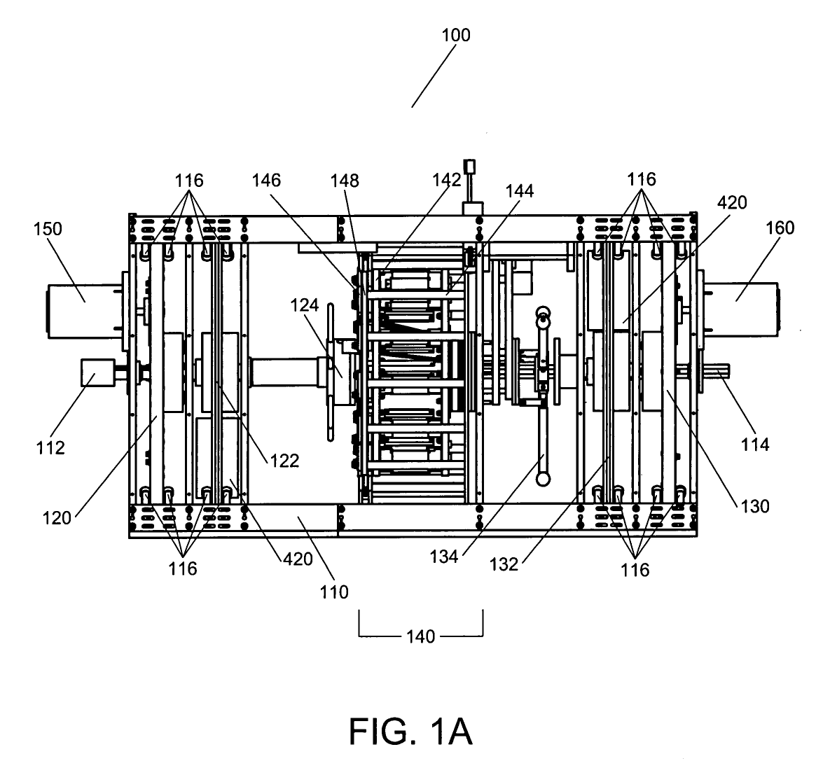

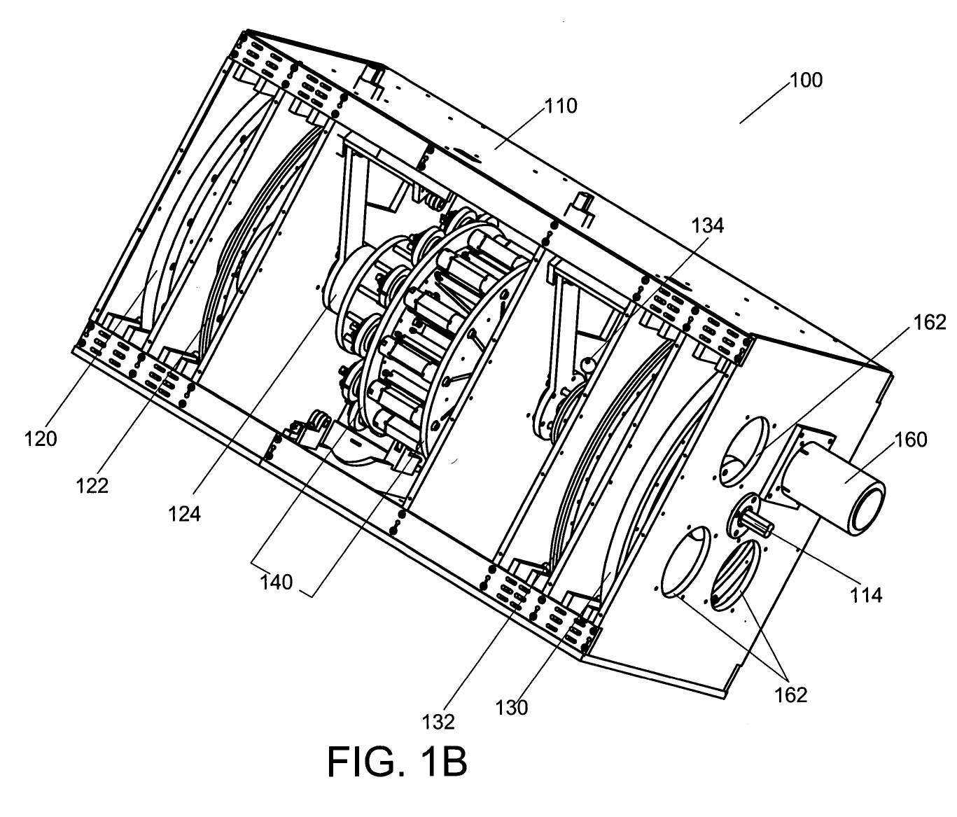

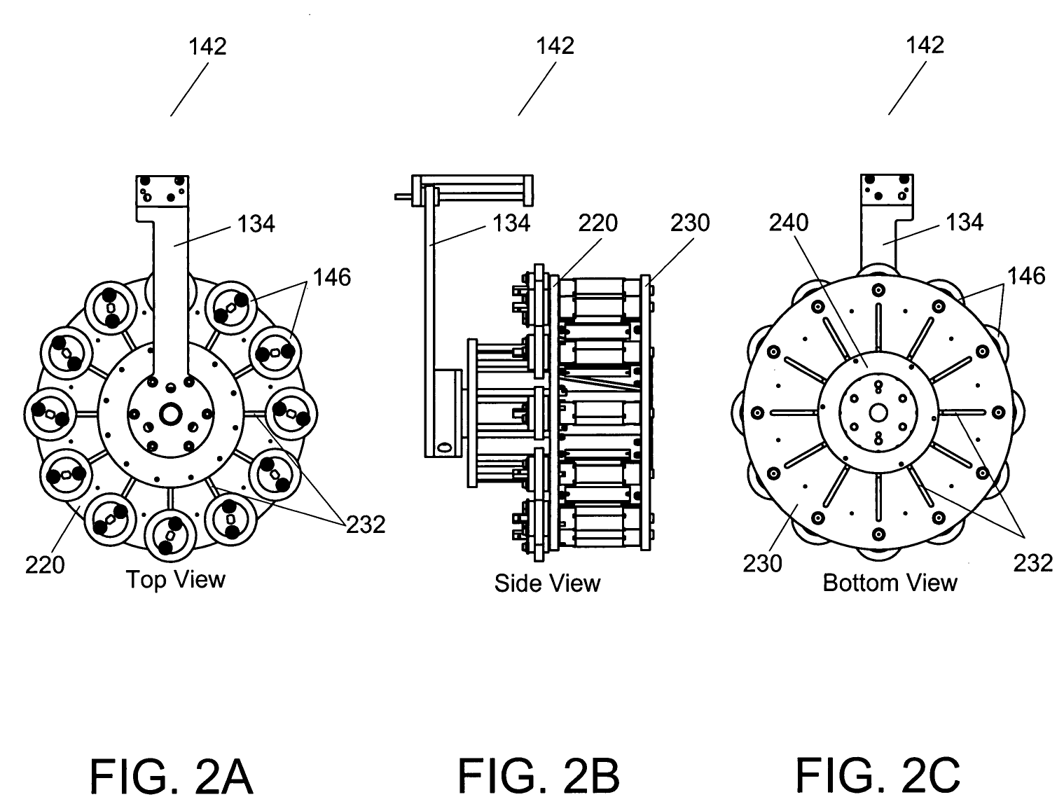

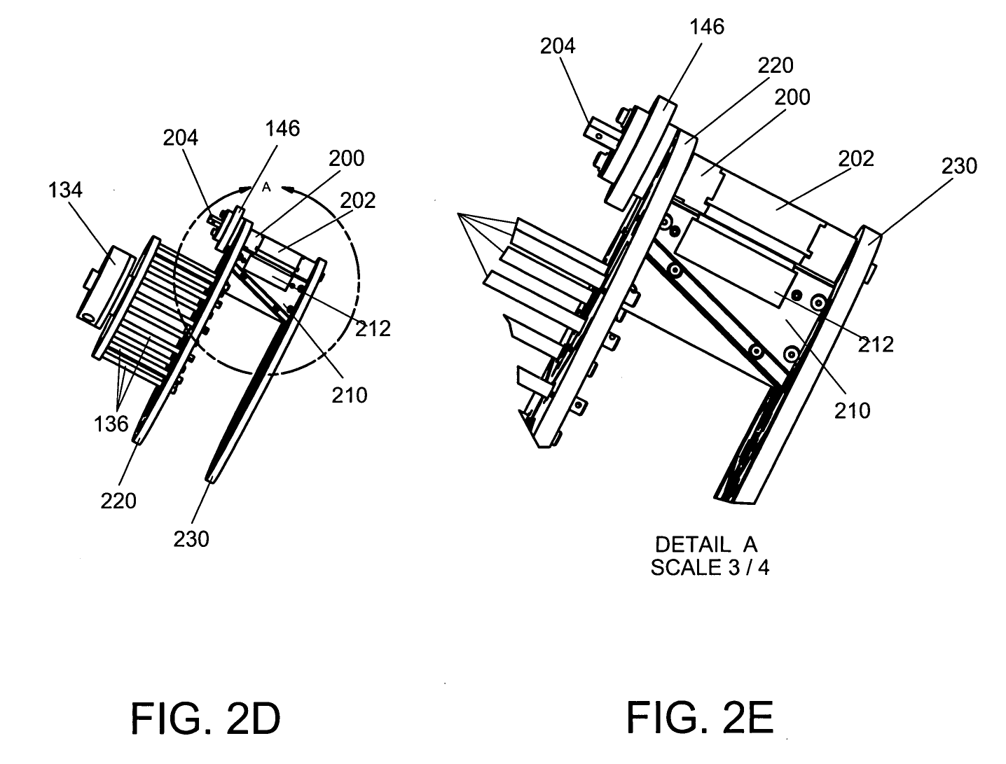

As shown in FIGS. 1A-2E, the high efficiency torque converter 100 includes the following three major components: a primary flywheel 120, a secondary flywheel 130, and a magnetic drive assembly 140. The magnetic drive assembly includes a primary drive assembly 142 and a secondary drive assembly 144.

With reference to FIGS. 1A and 1B, the primary flywheel 120 and primary drive assembly 142 are coupled to a primary shaft 112 which is rotatably coupled to a frame 110. The secondary flywheel 130 and secondary drive assembly 144 are coupled to a secondary shaft 114 which is rotatable coupled to the frame 110. The primary and secondary flywheels 120, 130 freely rotate within bearings 116 coupled to the frame 110. The bearings 116 can be frictionless bearings or any other known bearing in the art. The primary drive assembly 142 and a secondary drive assembly 144 are rotatably coupled to each other through a rotor gear 146 in the primary drive assembly 142 and a secondary drive gear 148 in the secondary drive assembly 144. The frame 110 contains a plurality of input/output holes/slots 162 which allow the coupling of input devices 150 (FIG. 1A) and output devices 160 to the torque converter 100.

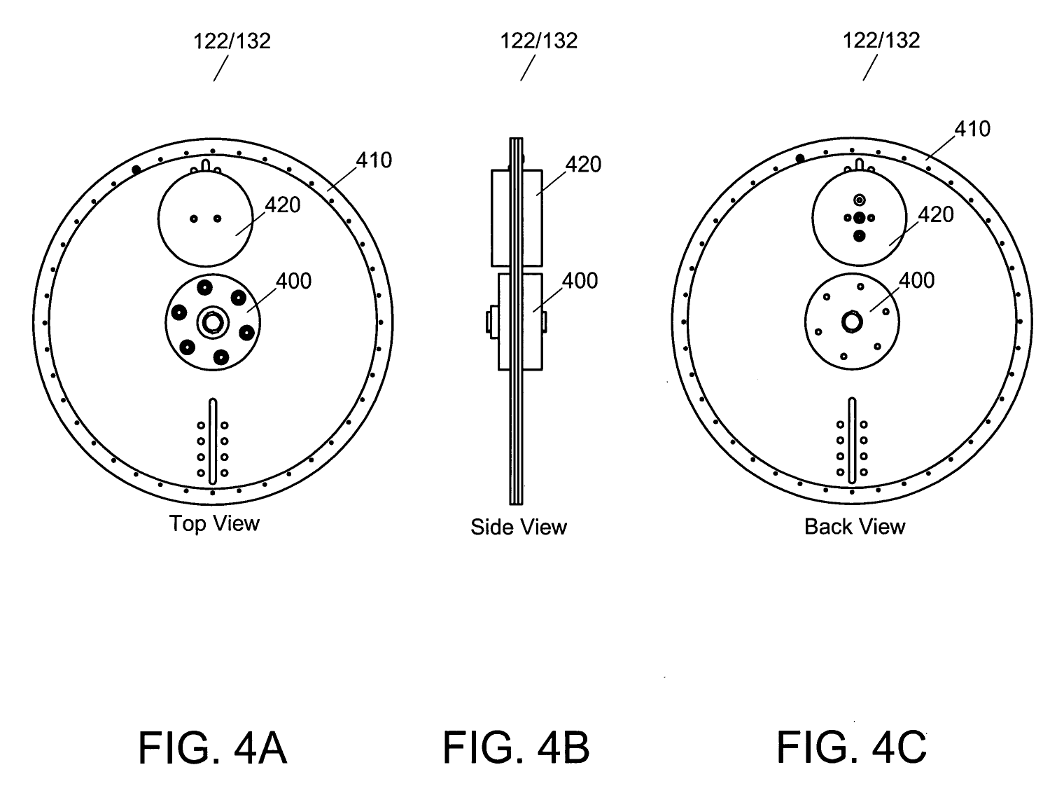

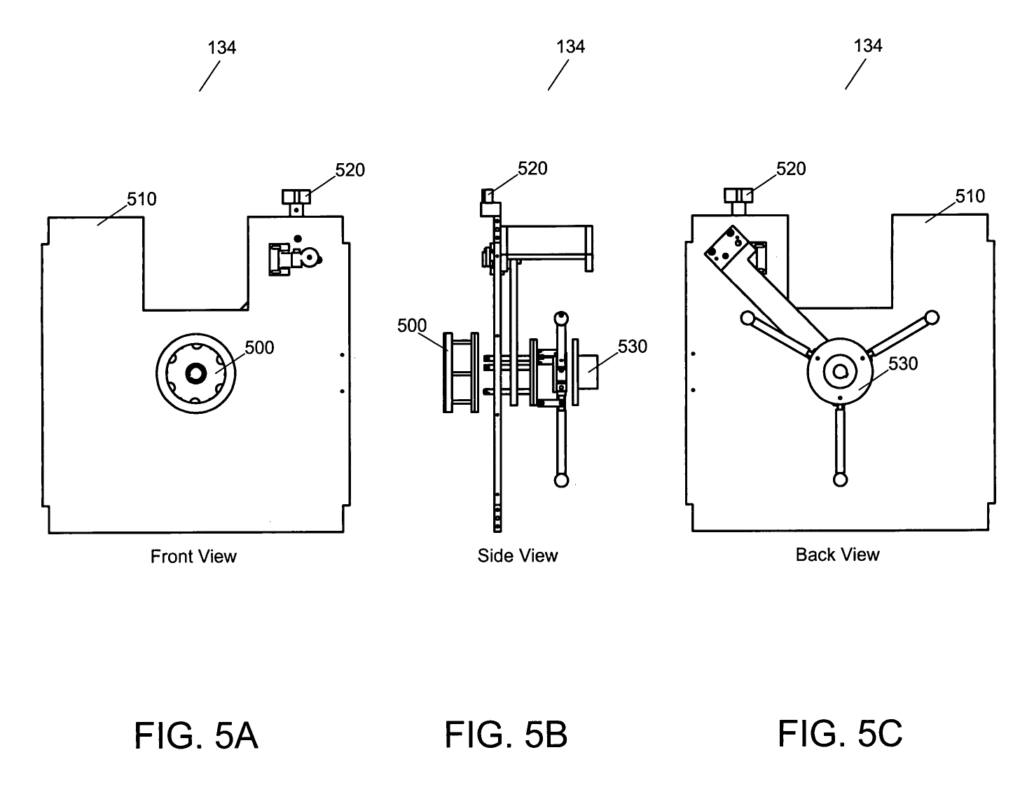

Optional components include a primary weighted flywheel 122, a gap adjustment assembly 124, a secondary weighted flywheel 132, and a brake/speed assembly 134. These components are described below with reference to FIGS. 4-5C.

As shown in FIGS. 2A-2E, the primary drive assembly 142 includes one or more corresponding rotor/stator assemblies 200,210, a top plate 220, and a bottom plate 230. The top plate 220 and bottom plate 230 including a mounting hub 250 for coupling to the primary shaft 112. Although twelve sets of rotor/stator assemblies are shown it should be understood that any amount of assemblies can be used depending upon the application. The top plate 220 and the bottom plate 230 should be made from a non-magnetic material, such as 60/61 aluminum or jig plate.

As shown in FIGS. 2D and 2E, each rotor assembly 200 includes a rotor magnet 202, a rotor shaft 204, and a rotor gear 146 which is rotatably coupled between the top plate 220 and the bottom plate 230. Each stator assembly 210 includes a stator magnet 212 which is fixedly coupled between the top plate 220 and the bottom plate 230. Each stator assembly 210 should be fixed within close proximity to its corresponding rotor assembly 200, such that opposite magnetic poles face each other. For example, the north pole of the rotor magnet 202 should face the south pole of the stator magnet 212. The gap between the rotor magnet 202 and the stator magnet 212 should be between 0.01 inch and 2 inches. An optional gap adjustment assembly 134 can be coupled to the primary drive assembly 142 to allow adjustment of the gap between the rotor magnet 202 and the stator magnet 212. Adjustment slots 232 can be provided in the top plate 220 and bottom plate 222 to allow the stator assembly 210 to be slidably moved between the rotor assembly 200 and mounting hub 250. Gap adjusters 136 hold the stator assembly 210 in a fixed position.

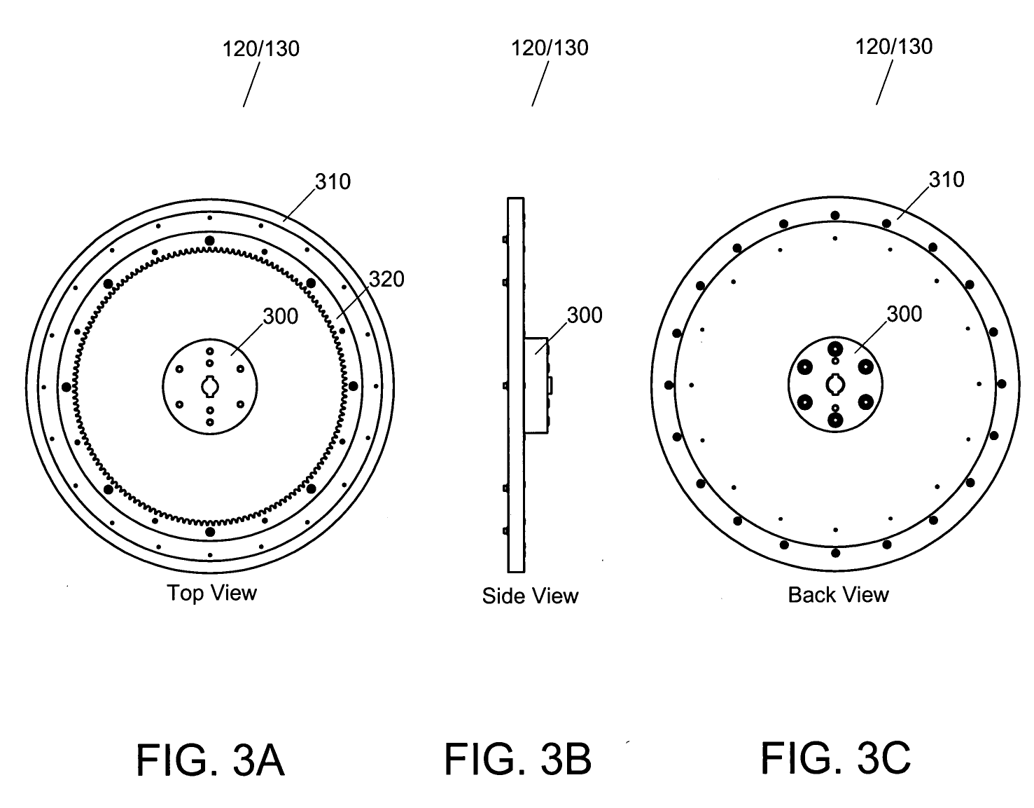

FIGS. 3A-3C show a flywheel assembly 120,130. The flywheel assembly 120,130 includes a mounting hub 300, a bearing surface 310, and a power transfer gear 320. The mounting hub 300 couples the flywheel assembly 120,130 to a primary shaft 112 or a secondary shaft 114. The bearing surface 310 is made from a material which allows near frictionless rotation of the flywheel 120,130. The power transfer gear 320 allows input device and output devices 150, 160 to be rotatably coupled to the high efficiency torque converter 100. It should be understood that shafts 112,114 can be used to transfer power to and from the high efficiency torque converter 100.

FIGS. 4-4C show an optional weighted flywheel 122,132. The optional weighted flywheel 122,132 includes a mounting hub 400, a bearing surface 410, a weight 420, and weight mounting slots 422. As shown in FIGS. 1A and 1B, a pair of optional weighted flywheels can be mounted to the high efficiency torque converter; one as a primary weighted flywheel 122 and the other as a secondary weighted flywheel 132. The weights 420 of each weighted flywheel 122,132 should be positioned to have a 12/6 o'clock orientation as shown in FIG. 1A. The mounting hub 400 couples the flywheel assembly 120,130 to the primary or the secondary shafts 112,114 (FIGS. 1A and 1B). The bearing surface 410 is made from a material which allows near frictionless rotation of the weighted flywheel 122/132.

FIGS. 5A-5C show an optional brake/speed assembly 134. The brake/speed assembly 134 includes a brake pad 500, a vertical plate 510, a tension control 520, and a flyball assembly 530. The brake/speed assembly 134 can be coupled to frame between the secondary drive assembly 144 and the secondary flywheel 130 or secondary weighted flywheel 132. The brake pad 500 rotatably mates with brake disc 240 on the primary drive assembly 142 (FIG. 2C). Rotation of the tension control increases/decreases force of the brake pad 500 on the brake disc 240 to speedup, slow down, or stop the primary drive assembly 142 from rotating. The flyball assembly 530 provides the user a visual aid in determining the speed of the primary drive assembly 142.

Operation of the torque converter 100 will be explained with reference to FIGS. 1A-2E. The mechanical or electromechanical source 150 rotates the primary flywheel 120. The primary flywheel 120 in turn rotates the primary drive assembly 142. As the primary drive assembly 120 turns, the rotor assemblies 200 begin to rotate or twist creating a short arc by virtue of the secondary drive gear 148 coupled to the secondary flywheel 130 which lags in rotation. The rotation of the rotor assemblies 200 creates a magnetic imbalance between the rotor magnet 202 and its associated stator magnet 212. This magnetic imbalance induces a reactive force which tries to return the rotor and stator magnets 202, 212 to a balanced position. This pulsed or oscillated reactive force is transferred through the rotor drive gears 146 to the secondary drive gear 148 causing the secondary drive flywheel 130 to catch or lead in rotation, thereby substantially reducing the load on the source 150.

The pulse or oscillated cycle is continually repeated during rotation of the primary flywheel 120 since the secondary flywheel 130 always continues to lag. The arc between the rotor magnet 202 and the stator magnet 212 and secondary flywheel lag decreases as the revolutions per minutes (rpm) of the converter 100 increases. The arc between the rotor magnet 202 and the stator magnet 212 is at a minimum when a steady-state rpm is achieved, i.e. where the magnetic force density is the greatest. The pulse or oscillating movement of the secondary flywheel 130 provides an increased efficiency of the overall system, such that the source 150 is able to accelerate more rapidly from a starting position, and a higher velocity may be obtained for a given input power to the source 150.

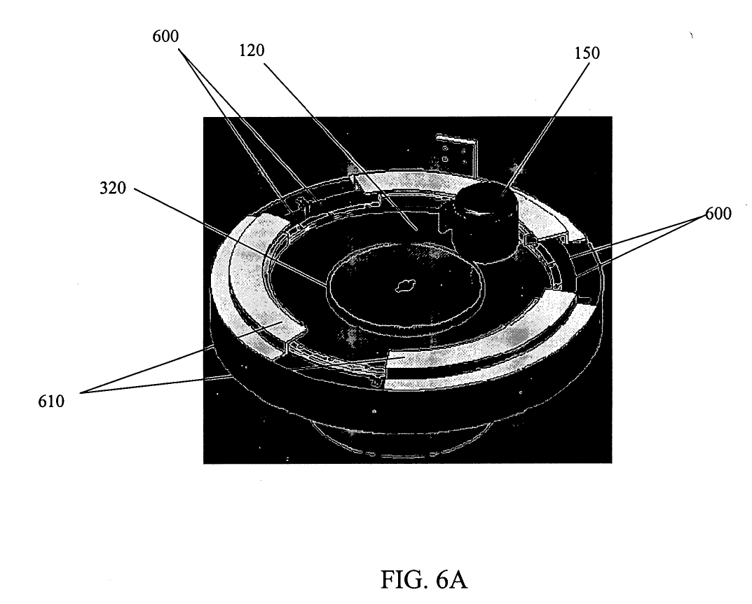

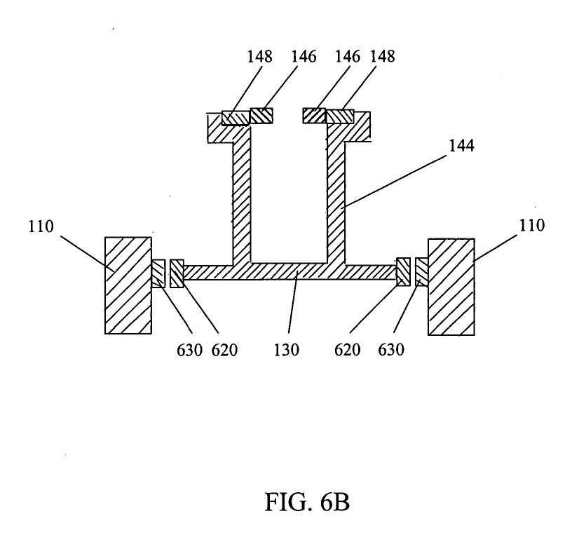

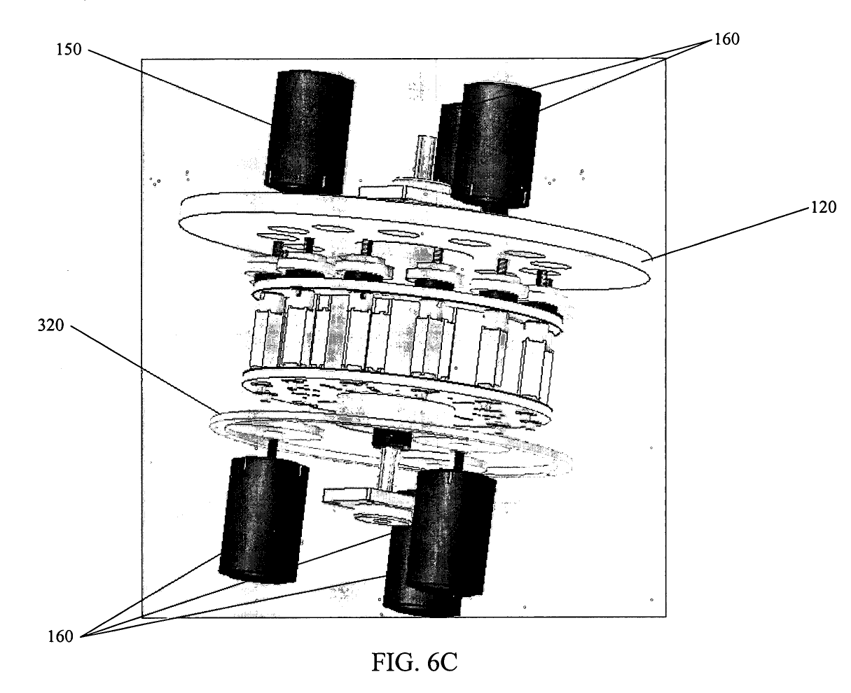

As shown in FIG. 6A, the primary side of the torque converter 100 (FIGS. 1A and 1B) can be adapted to be a self sustaining electrical generation system. The torque converter 100 is driven by an electric motor 150 initially powered from an external source. The motor 150 is coupled to the primary flywheel 120 in a manner to mesh the motor drive gear with the power transfer gear 320 located on the primary flywheel 120. A plurality of magnets 600 are mounted in a continuous ring on the outside edge of the primary flywheel 120. Each magnet 600 is oriented in the same direction to mate the positive side of one magnet 600 to the negative side of the adjacent magnet 600. Field pick-up coils 610 are mounted to the frame 110 (FIGS. 1A and 1B). Each field pickup coil 610 can provide an individual output. The output of each field pickup coil 610 can be designed to provide a direct current (dc) output, for example an output of 24 volts dc at 15 amperes. The output can be inverted to a desired alternating current (ac) output, for example 110-120 volts ac. To provide a self sustaining system, one of the outputs from a field pickup coil 310 can be routed to provide power to the motor 150, at which time the external power, that provides start-up power, can be removed.

As shown in FIG. 6B, the secondary side of the torque converter 100 (FIGS. 1A and 1B) can be adapted to be an electrical generation system. The secondary drive assembly 144 includes a secondary drive gear 148 which rotatably interacts with rotor gears 146 as explained above. The secondary flywheel 130 is coupled to the secondary drive assembly 144. A plurality of magnets 620 are mounted in a continuous ring to the outside edge of the secondary flywheel 130. Each magnet 620 is oriented in the same direction to mate the positive side of one magnet 620 to the negative side of the adjacent magnet 620. Field pick-up coils 630 are mounted to the frame 110 (FIGS. 1A and 1B). Each pickup coil 630 can provide an individual output. The output of each field pickup coil 630 can be designed to provide a direct current (DC) output, for example an output of 24 volts dc at 15 amperes. The output can be inverted to a desired alternating current (AC) output, for example 110-120 volts ac.

As shown in FIG. 6C, the torque converter 100 (FIGS. 1A and 1B) can be adapted to be a self sustaining electrical generation system using external generators. The torque converter 100 is driven by an electric motor 150 initially powered from an external source. The motor 150 is coupled to the primary flywheel 120 in a manner to mesh the motor drive gear with the power transfer gear 320 located on the primary flywheel 120. One or more generators 160 can also be mounted to mesh the motor drive gear with the power transfer gear 320 located on the primary flywheel 120 and the secondary flywheel (not shown). Each generator can provide an either an AC or DC output, for example to 110-120 vac or 24 vdc. To provide a self sustaining system, one of the outputs from a generator 160 can be routed to provide power to the motor 150, at which time the external power, that provides start-up power, can be removed.

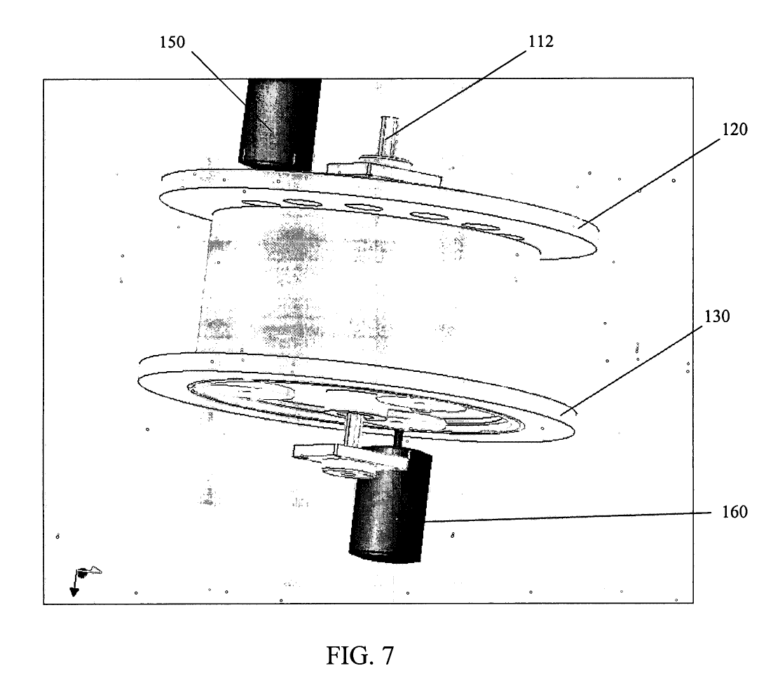

As shown in FIG. 7, the primary side of the torque converter 100 (FIGS. 1A and 1B) can be adapted to be a self sustaining mechanical drive system. The torque converter 100 is driven by an electric motor 150 initially powered from an external source. The motor 150 is coupled to the primary flywheel 120 in a manner to mesh the motor drive gear with the power transfer gear 320 located on the primary flywheel 120. A generator 160 can also be mounted to mesh the motor drive gear with the power transfer gear 320 located on either the primary flywheel 120 and the secondary flywheel 130. Mechanical output is provided by the primary shaft 112 which is driven by the primary flywheel 120. To provide a self sustaining system, one of the outputs from a generator 160 can be routed to provide power to the motor 150, at which time the external power, that provides start-up power, can be removed.

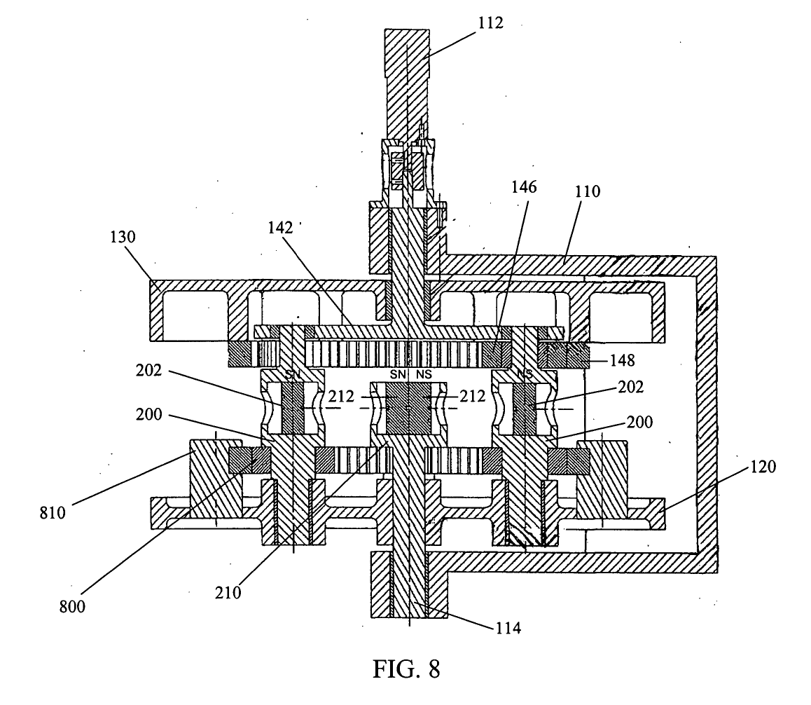

FIG. 8 shows a cross-section view of another embodiment of the torque converter 100 of FIGS. 1A and 1B. A torque converter is coupled between a driving input such as an electrical motor and a drive output. As shown in the cross-sectional view, the input from the electrical motor is coupled to a primary shaft 112. A primary drive 142 driven directly by the primary shaft 112 drives two or more rotor assemblies 200 to revolve about the center axis of the primary shaft 112. The rotor assemblies 200 directly drive a primary flywheel 120 coupled to a secondary shaft 114. A rotor gear 146 coupled to the rotor assembly 200 is coupled to a secondary drive gear 148, which is in turn coupled to a secondary flywheel 130. Each rotor assembly 200 supports a permanent magnet 202. A stator assembly 210 comprised of two permanent magnets forced to have like poles held together is located on the secondary shaft 114. The rotor assemblies 200 rotate about their individual axes, and are caused to rotate together by an internal gear 800 which rides in the bearings of a number of guides 810.

In the resting position, the magnets are aligned as illustrated. As the primary shaft 112 is driven, the primary flywheel 120 and the output shaft 114 are directly driven through the primary assembly 142 and the rotor assemblies 200. The secondary flywheel 130 initially lags and thus rotates one of the rotor assemblies 200 and associated magnet 202 through the secondary drive gear 148. Rotation of the one rotor assembly 200 rotates the others through the internal gear 800 mounted in the guides 810. Rotation of the rotor magnets 202 opposes the magnetic force with the center magnet 212. Subsequently, the drawing force from the center magnet 212 to reorient the rotor magnets 202 causes the secondary fly wheel 130 to drive forward relative to the primary flywheel 120 to catch or even pass the primary flywheel 120. There is then a substantially reduced load on the drive motor. The secondary flywheel 130 will then again lag the primary flywheel 120 and the system continues in an oscillating motion. The oscillating movement of the secondary flywheel 130 results in increased efficiency of the overall system such that the motor is able to accelerate more rapidly from a starting position and a higher velocity may be obtained for a given input power to the motor.

Neodymium magnets are particularly useful due to their high magnetic strength per size. Although the stator assembly 210 is illustrated as back-to-back linear magnets 212, a circular magnet having an opposite polarity about its circumference relative to a center pole may also be used. Other mechanisms for coupling of the magnets to the flywheels, such as through different gear arrangements, may also be used. The magnetic drive assembly 140 of FIGS. 1A and 1B can be adapted to use the internal gear 800 of FIG. 8 to create the magnetic imbalance in the torque converter 100.

While this invention has been particularly shown and described with references to preferred embodiments thereof, it will be understood by those skilled in the art that various changes in form and details may be made therein without departing from the scope of the invention encompassed by the appended claims.

What is claimed is:

1. A torque converter, comprising:
a primary flywheel;
a secondary flywheel; and
a magnetic drive assembly magnetically and mechanically coupling the primary flywheel and the secondary flywheel.

2. The torque converter of claim 1, wherein the magnetic drive assembly includes:
a fixed magnet; and
a rotatable magnet magnetically aligned and balanced to the fixed magnet through opposite magnetic poles, rotation of the rotatable magnet creating a magnetic imbalance between the fixed magnet and the rotatable magnetic, the magnetic imbalance magnetically driving the secondary flywheel.

3. The torque converter of claim 2, wherein the fixed magnet and the rotatable magnet are Neodymium magnets.

4. The torque converter of claim 2, further comprising a gap adjustor assembly for adjusting a gap between the fixed magnet and the rotatable magnet.

5. The torque converter of claim 4, wherein the gap is between 0.01 inch and 2 inches.

6. The torque converter of claim 1, further comprising:
a primary weighted flywheel coupled between the primary flywheel and the magnetic drive assembly; and
a secondary weighted flywheel coupled between the secondary flywheel and the magnetic drive assembly.

7. The torque converter of claim 1, further comprising a braking assembly coupled between the magnetic drive assembly and the secondary flywheel.

8. The torque converter of claim 1, further comprising a mechanical input coupled to the primary flywheel.

9. The torque converter of claim 1, wherein the mechanical input is an electric motor, a waterwheel, a windmill, or a turbine.

10. The torque converter of claim 8, further comprising a mechanical output coupled to either the primary flywheel or the secondary flywheel.

11. The torque converter of claim 10, wherein power created from the mechanical output is routed to the mechanical input to provide a self-sustaining system.

12. A torque converter, comprising:
a mechanical input;
a primary flywheel coupled to the input;
a secondary flywheel;
an oscillating coupling between the primary flywheel and the secondary flywheel; and
a mechanical output coupled to either the primary flywheel or the secondary flywheel.

13. The torque converter of claim 12, wherein the oscillating coupling comprises:
a mechanical coupling driving the secondary flywheel when a magnetic drive assembly is balanced; and
a magnetic coupling driving the secondary flywheel when the magnetic drive assembly is imbalanced.

14. The torque converter of claim 13, wherein the magnetic assembly includes:
a fixed magnet; and
a rotatable magnet magnetically aligned and balanced to the fixed magnet through opposite magnetic poles, rotation of the rotatable magnet creating a magnetic imbalance between the fixed magnet and the rotatable magnetic.

15. The torque converter of claim 14, wherein the fixed magnet and the rotatable magnet are Neodymium magnets.

16. The torque converter of claim 14, further comprising a gap adjustor assembly for adjusting a gap between the fixed magnet and the rotatable magnet.

17. The torque converter of claim 16, wherein the gap is between 0.01 inch and 2 inches.

18. The torque converter of claim 13, further comprising:
a primary weighted flywheel coupled between the primary flywheel and the magnetic drive assembly; and
a secondary weighted flywheel coupled between the secondary flywheel and the magnetic drive assembly.

19. The torque converter of claim 13, further comprising a braking assembly coupled between the magnetic drive assembly and the secondary flywheel.

20. The torque converter of claim 12, wherein the mechanical input is an electric motor, a waterwheel, a windmill, or a turbine.

21. The torque converter of claim 12, wherein power created from the mechanical output is routed to the mechanical input to provide a self-sustaining system.

22. A torque converter, comprising:
a mechanical input;
a mechanical output coupled to the input;
a driven flywheel; and
an oscillating coupling between the output and the driven flywheel.

23. A torque converter as claimed in claim 22, further comprising a drive flywheel directly driven by the mechanical input, and wherein the oscillating coupling comprises a magnetic coupling between the two flywheels.

24. A torque converter as claimed in claim 23, wherein the magnetic coupling comprises a centered permanent magnet and rotatable permanent magnets which rotate to be non-aligned with the centered fixed magnet.

25. A torque converter, comprising:
a mechanical input;
a drive flywheel driven by the mechanical input and coupled to a mechanical output;
a driven flywheel; and
a magnetic coupling between the drive flywheel and the driven flywheel.

26. A torque converter as claimed in claim 25, wherein the magnetic coupling comprises a centered permanent magnet which rotates with the drive flywheel and rotatable permanent magnets which rotate to be non-aligned with the centered permanent magnet.

27. A method for improving efficiency in a torque converter, comprising:
inputting mechanical energy into a primary flywheel;
producing magnetic energy using the primary flywheel;
oscillating between the mechanical energy and the magnetic energy to drive a secondary flywheel; and
outputting mechanical energy from the secondary flywheel.

28. The method of claim 27, wherein the mechanical energy is generated from an electric motor, a waterwheel, a windmill, or a turbine.

29. The method of claim 27, wherein the magnetic energy is produced by rotating a like pole on a rotatable magnet to close proximity to a like pole on a fixed magnet.

30. The method of claim 27, wherein oscillation occurs when the magnetic energy is sufficient in strength to overcome the mechanical energy.

31. The method of claim 31, wherein the energy outputted from the secondary flywheel is inputted into the primary flywheel to create a self-sustaining system.

32. A torque converter, comprising:
means for providing a mechanical input;
means for providing a magnetic input;
means for switching between the mechanical input and the magnetic input to provide a mechanical output.
